(19) United States
(12) Patent Application Publication
(10) Pub. No.: US 2024/0337801 A1
(43) Pub. Date: Oct. 10, 2024

(54) UNITARY OPTICAL FIBRE RIBBON

(71) Applicant: Sterlite Technologies Limited, Gurugram (IN)

(72) Inventors: Marquesha McVea, Lugoff, SC (US); Steven Beasley, Lugoff, SC (US)

(21) Appl. No.: 18/601,844

(22) Filed: Mar. 11, 2024

Related U.S. Application Data
(60) Provisional application No. 63/494,540, filed on Apr. 6, 2023.

(51) Int. Cl. G02B 6/44

(52) U.S. Cl. CPC G02B 6/4403

(57) ABSTRACT

Disclosed is a unitary optical fibre ribbon (100, 170, 200, 300, 400, 500, 600, 700). The unitary optical fibre ribbon (100, 200, 300, 400, 500, 600, 700) has a plurality of optical fibres (112) sandwiched between a plurality of layers of resin (130). The plurality of layers of resin (130) has two or more flat regions (160) and at least one split-inducing region (150). The at least one split-inducing region (150) is positioned between one or more pairs of adjacent optical fibres (112). The unitary optical fibre ribbon (100, 200, 300, 400, 500, 600, 700) is fractured at the at least one split-inducing region (150) by application of an external force in the range of 0.1 Newton to 0.5 Newton.

### CROSS-REFERENCE TO RELATED APPLICATIONS

This application claims the benefit of U.S. provisional Application No. 63/494,540 titled A UNITARY OPTICAL FIBRE RIBBON filed by the applicant on Apr. 6, 2023, which is incorporated herein by reference in its entirety.

### FIELD OF THE INVENTION

The present invention relates to optical fibre ribbons and more particularly to unitary optical fibre ribbons.

### BACKGROUND OF THE INVENTION

Fibre optic cables (i.e., optical cables) are commonly used for data transfer and communications in a variety of networking applications. The typical fibre optic cables use loose optical fibres or optical fibre ribbons. Use of optical fibre ribbons provide an advantage of easy splicing. A typical optical fibre ribbon has 12 optical fibres. With the ever-increasing demand for higher fibre count ribbons, it is becoming challenging to increase number of optical fibres in a ribbon while allowing easy mid-spanning during deployment and developing a low-cost high-yield manufacturing process.

There are a few known 24 fibre flat ribbons. In one such known ribbon, a typical manufacturing method is used with more than 12 optical fibres. The ribbon is formed by placing more than 12 optical fibres in parallel and covering with a coating to form a ribbon. In another known ribbon, two 12-fibre flat ribbons are joined together by heat shrinking a thermoplastic wire between the two standard 12-fibre flat ribbons. In yet another known ribbon, two 12-fibre flat ribbons are joined together by coating with an additional soft layer on top of the ribbons.

However, the above prior art ribbons suffer from one or more of the following limitations. One or more of the above ribbons does not allow easy mid-spanning. Moreover, one or more of the above ribbons require multiple pass of manufacturing process that increases cost, increases the process time, reduces the capacity of production, and so forth.

Therefore, there is a need for a flat ribbon that overcomes one or more limitation associated with the prior art.

### SUMMARY OF THE INVENTION

In an aspect of the present disclosure, a unitary optical fibre ribbon is disclosed. The unitary optical fibre ribbon has a plurality of optical fibres sandwiched between a plurality of layers of resin. The plurality of layers of resin has two or more flat regions and at least one split-inducing region. The at least one split-inducing region is positioned between one or more pairs of adjacent optical fibres. The unitary optical fibre ribbon is fractured at the at least one split-inducing region by application of an external force in the range of 0.1 Newton to 0.5 Newton.

### BRIEF DESCRIPTION OF THE DRAWINGS

The embodiments of the invention are illustrated in the accompanying drawings, throughout which like reference letters indicate corresponding parts in the various drawings. The invention herein will be better understood from the following description with reference to the drawings, in which:

FIG. 1A illustrates a perspective view of a unitary optical fibre ribbon.

FIG. 1B illustrates a perspective sectional view of the unitary optical fibre ribbon of FIG. 1A.

FIG. 1C illustrates another perspective view of the unitary optical fibre ribbon of FIG. 1A.

FIGS. 1D and 1E illustrate isometric cross-sectional views of the unitary optical fibre ribbon of FIG. 1A.

FIG. 1F illustrates an isometric a sectional view of the unitary optical fibre ribbon of FIG. 1A.

FIG. 1G illustrates an isometric cross-sectional view of a unitary optical fibre ribbon.

FIG. 2 illustrates a perspective sectional view of a unitary optical fibre ribbon.

FIG. 3 illustrates a perspective view of a unitary optical fibre ribbon.

FIG. 4 illustrates a perspective view of a unitary optical fibre ribbon.

FIG. 5 illustrates a perspective view of a unitary optical fibre ribbon.

FIG. 6 illustrates an isometric sectional view of a unitary optical fibre ribbon.

FIG. 7 illustrates an isometric sectional view of a unitary ribbon.

FIG. 8 illustrates a block diagram of a method 800 for manufacturing the unitary optical fibre ribbon of FIG. 1A to FIG. 7.

### DETAILED DESCRIPTION

The detailed description of the appended drawings is intended as a description of the currently preferred aspects of the present disclosure, and is not intended to represent the only form in which the present disclosure may be practiced. It is to be understood that the same or equivalent functions may be accomplished by different aspects that are intended to be encompassed within the spirit and scope of the present disclosure.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

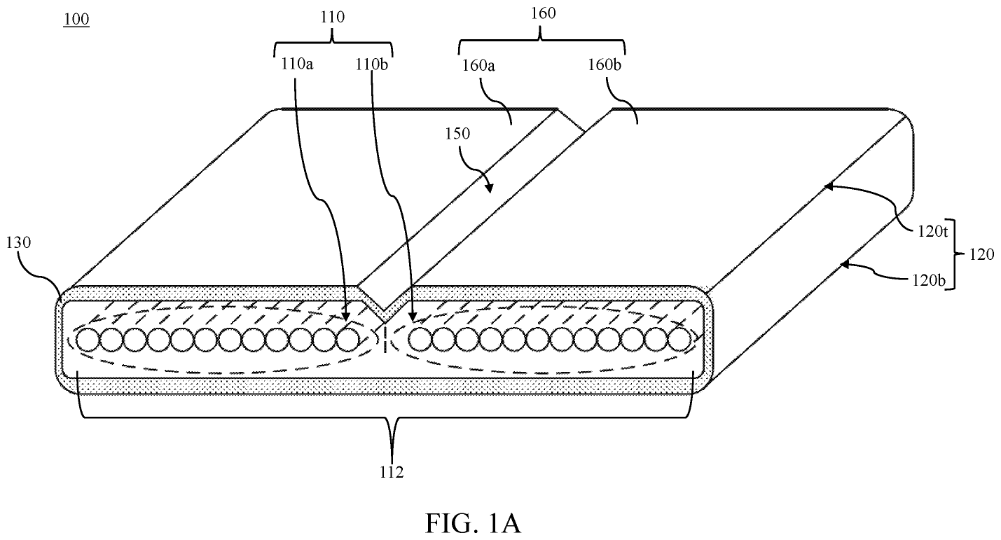

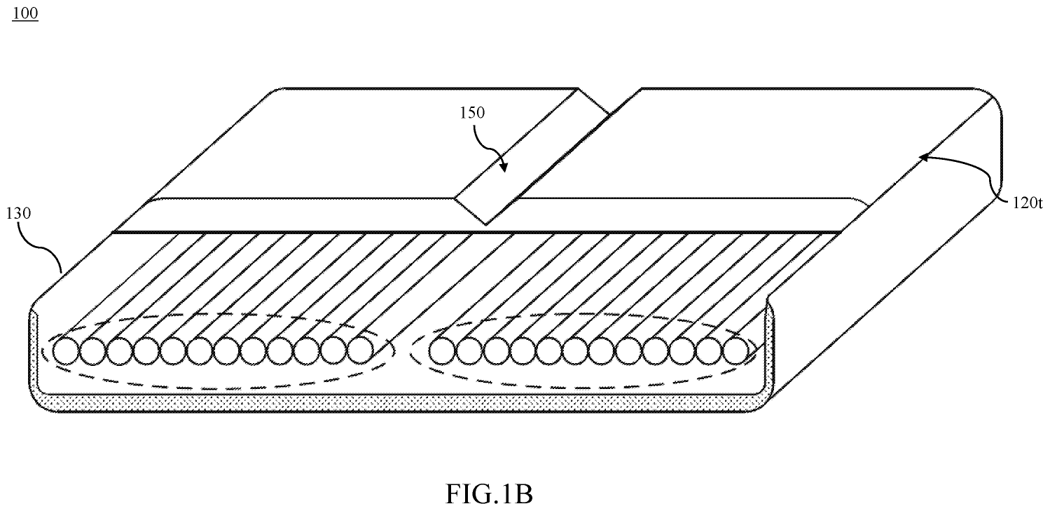

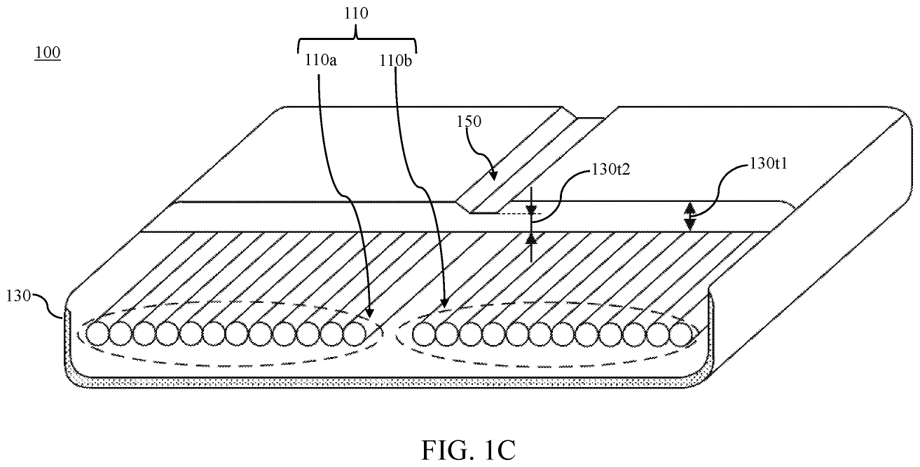

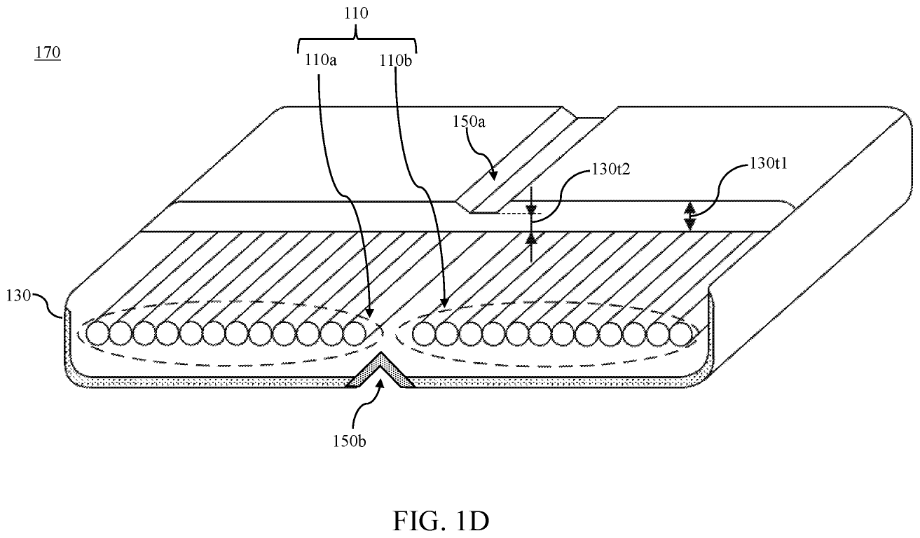

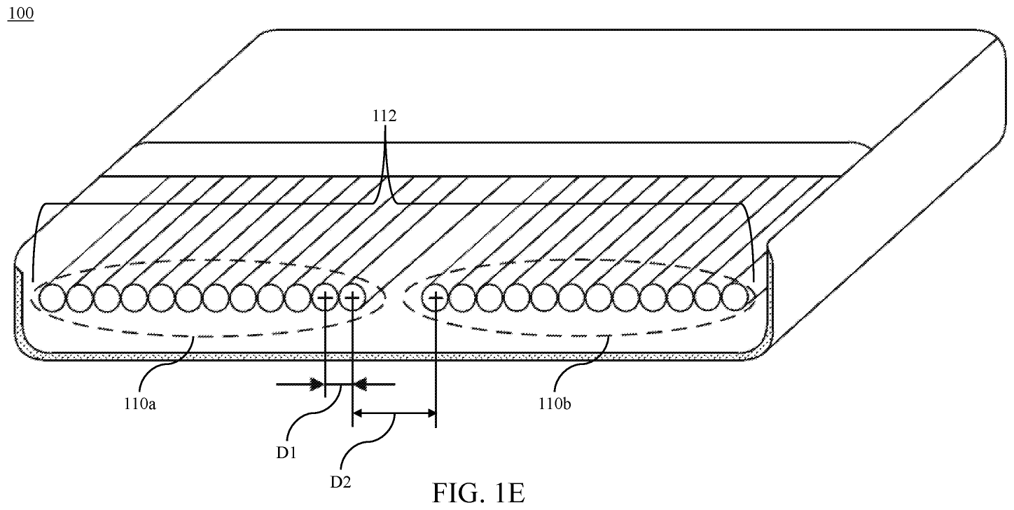

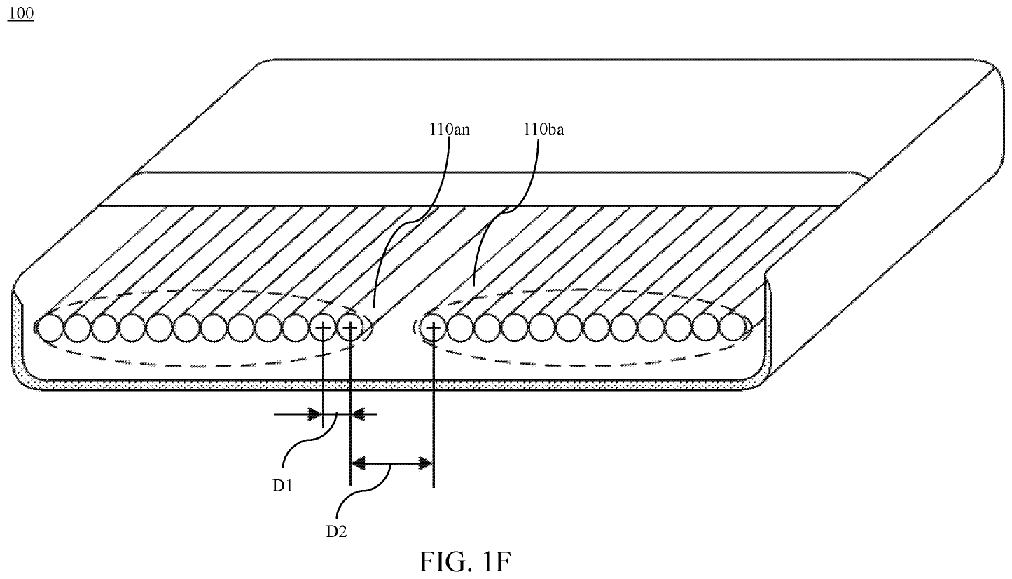

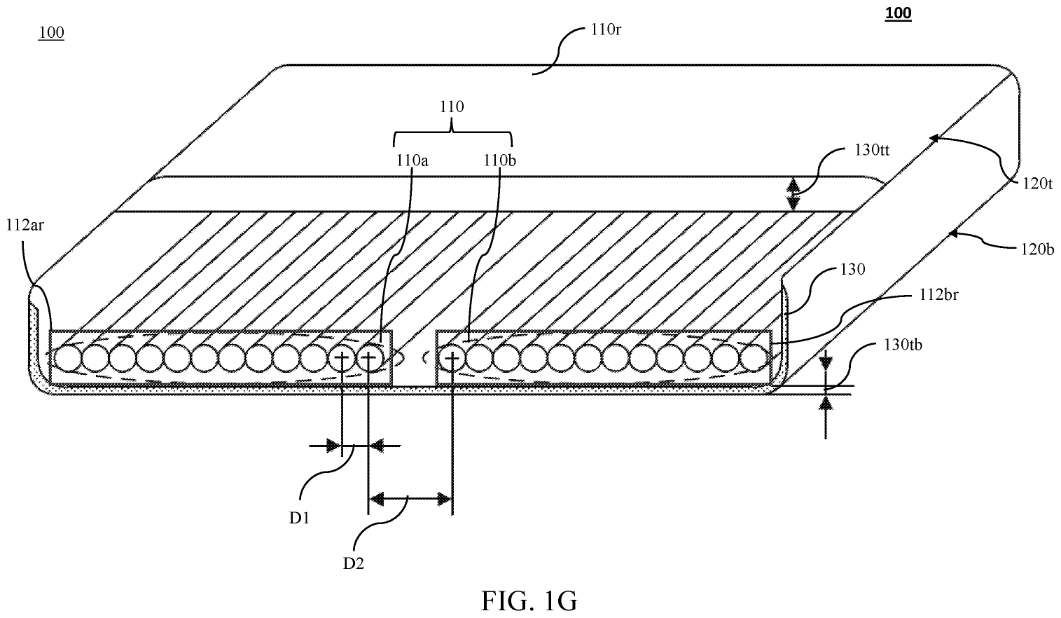

FIG. 1A illustrates a perspective view of a unitary optical fibre ribbon 100. The unitary optical fibre ribbon 100 may have a plurality of optical fibres 112 sandwiched between a plurality of layers of resin 130 (hereinafter interchangeably referred to and designated as “the single resin coat 130”). As illustrated, the plurality of optical fibres 112 may be divided into a plurality of sets 110 of which first and second sets 110a and 110b are shown. The first and second sets 110a and 110b of the plurality of optical fibres 112 may be sandwiched between the single resin coat 130 such that the single resin coat 130 surrounds the plurality of optical fibres 112. The plurality of layers of resin 130 may have two or more flat regions 160 and at least one split-inducing region 150. In an aspect of the present disclosure, the two or more flat regions 160 may have first and second flat regions 160a and 160b. The at least one split-inducing region 150 may be positioned between one or more pairs of adjacent optical fibres of the plurality of optical fibres 112. In other words, the at least one split-inducing region 150 may be positioned between adjacent pair of optical fibres of the plurality of optical fibres 112 where a split may be desired to divide the unitary optical fibre ribbon 100 in minimum two parts. As illustrated, the at least one split-inducing region 150 may be a V-shaped groove that runs along a length of the unitary optical fibre ribbon 100. In some aspects of the present disclosure, the at least one split-inducing region 150 may be a U-shaped groove that runs along a length of the unitary optical fibre ribbon 100. In some aspects of the present disclosure, the at least one split-inducing region 150 may be a V-shaped groove that runs along a length of the unitary optical fibre ribbon 100. The first and second flat regions 160a and 160b may be defined as all the regions of the unitary optical fibre ribbon 100 excluding the split-inducing regions 150. Although FIG. 1A illustrates that the plurality of sets 110 has two sets (i.e., the first set 110a and the second set 110b), it will be apparent to a person skilled in the art that the scope of the present disclosure is not limited to it. In various other aspects, the plurality of sets 110 may have any number of sets, without deviating from the scope of the present disclosure. Each of the plurality of sets 110 may have one or more optical fibres of the plurality of optical fibres 112. In some aspects of the present disclosure, the first set 110a may have 12 optical fibres and the second set 110b has 12 optical fibres.

Further, the plurality of sets 110 may be arranged such that the plurality of sets 110 are joined together to form the unitary optical fibre ribbon 100. Each pair of adjacent optical fibres of the plurality of optical fibres 112 and each of the adjacent sets 110 may be joined together using a single and exactly same resin (i.e., the single resin coat 130). In some aspects of the present disclosure, the single resin coat 130 may be, but not limited to, a UV matrix specific UV acrylate, other compounded UV acrylate thermoset material, where the cross linking is achieved at a range of 50% to 100%, and the like. Aspects of the present disclosure are intended to include and/or otherwise cover any type of the material for the single resin coat 130 where the cross linking is achieved at the range of 50% to 100%, without deviating from the scope of the present disclosure.

The plurality of sets 110 may have a pair of surfaces 120 substantially parallel to each other. The single resin coat 130 may be disposed on the pair of parallel surfaces 120 such that the single resin coat 130 sandwiches the arranged plurality of sets 110 of optical fibres 112. The single resin coat 130 may be coated on the pair of surfaces 120 and subsequently cured to form the unitary optical fibre ribbon 100. The pair of surfaces 120 may have a top surface 120t and a bottom surface 120b such that the top surface 120t and the bottom surface 120b are substantially parallel to each other.

FIG. 1B illustrates a perspective sectional view of the unitary optical fibre ribbon 100. The unitary optical fibre ribbon 100 may be cross sectionally sliced along the top surface 120t. The unitary optical fibre ribbon 100 may be fractured at the at least one split-inducing region 150 by application of an external force on both sides of the at least one split-inducing region 150. Specifically, the external force required to fracture the unitary optical fibre ribbon 100 at the at least one split-inducing region 150 may be in a range of 0.1 Newton to 0.5 Newton. The unitary optical fibre ribbon 100 may be designed in a way such that to fracture the unitary optical fibre ribbon 100 through the split-inducing region 150, the external force required is in the range of 0.1 Newton to 0.5 Newton as manufacturing and handling of a unitary optical fibre ribbon that requires an external force less than 0.1 Newton is difficult. On the other hand, when a unitary optical fibre ribbon requires an external force greater than 0.5 Newton to fracture, such unitary optical fibre ribbons will need special tooling to clean split the ribbon in two or more parts. As illustrated, the at least one split-inducing region 150 may be a V-shaped groove that runs along a length of the unitary optical fibre ribbon 100. In some aspects of the present disclosure, the at least one split-inducing region 150 may be a U-shaped groove that runs along a length of the unitary optical fibre ribbon 100.

FIGS. 1C and 1D illustrates another perspective view of the unitary optical fibre ribbon 100. As discussed, the unitary optical fibre ribbon 100 may have the single resin coat 130. In some aspects of the present disclosure, the single resin coat 130 may have a coat thickness that varies along a width of the unitary optical fibre ribbon 100. Specifically, the coat thickness may have a first coat thickness 130t1 and a second coat thickness 130t2. Specifically, the first coat thickness 130t1 is a coat thickness of the single resin coat 130 over the plurality of sets 110. In other words, the first coat thickness 130t1 is the coat thickness of the single resin coat 130 over the first and second sets 110a and 110b. Further, the second coat thickness 130t2 is a coat thickness of the single resin coat 130 between the at least one of pair of adjacent sets of the plurality of sets 110. In other words, the second coat thickness 130t2 is the coat thickness of the single resin coat 130 between the first and second sets 110a and 110b formed due to a presence of the at least one split-inducing region 150. In some aspects of the present disclosure, the second coat thickness 130t2 may be less than the first coat thickness 130t1 of the single resin coat 130. Specifically, the second coat thickness 130t2 may be less than the first coat thickness 130t1 due to the presence of the at least one split-inducing region 150. As illustrated, the first coat thickness 130t1 of the single resin coat 130 over the plurality of sets 110 (i.e., the first and second sets 110a and 110b) is greater than the second coat thickness 130t2 of the single resin coat 130 in the split inducing regions 150. In some aspects of the present disclosure, the two or more flat regions 160 of the unitary optical fibre ribbon 100 may be defined by a first curing level of the single resin coat 130 and the at least one split-inducing region 150 may be defined by a second curing level of the plurality of layers of the single resin coat 130.

FIGS. 1E and 1F illustrate isometric cross-sectional views of the unitary optical fibre ribbon 100. The unitary optical fibre ribbon 100 may have a first pitch (D1) and a second pitch (D2). Specifically, the first pitch (D1) and the second pitch (D2) may be defined between the plurality of optical fibres 112 in the unitary optical fibre ribbon 100. The first pitch (D1) may bac defined as a centre-to-centre distance (i.e., a first distance) between adjacent optical fibres in each set of the plurality of sets 110 in the two or more flat regions 160 (the first and second flat regions 160a and 160b). Further, the second pitch (D2) may be defined as a centre-to-centre distance (i.e., a second distance) between a pair of adjacent optical fibres in adjacent sets of the plurality of sets 110. For example, the second pitch (D2) may be defined as a centre-to-centre distance between a last optical fibre 110an of the first set 110a and a first optical fibre 110ba of the second set 110b. In some aspects of the present disclosure, the second distance is greater than the first distance such that a ratio of D1 to D2 is less than 0.95. Specifically, a higher pitch D2 between a pair of adjacent optical fibres in adjacent sets of the plurality of sets 110 may ensure that there is enough resin material present around both the optical fibres after the split to maintain the mechanical integrity of both ribbons. The unitary optical fibre ribbon 100 with D1 to D2 ratio higher than 0.95 may not have sufficient resin material around both the end optical fibres of the split ribbons.

For example, the first pitch (D1) distance (i.e., a first distance) between adjacent optical fibres in each set of the plurality of sets 110 in the two or more flat regions 160 is same and is in an order of 250 microns. In another example, the pitch (D1) may be 180 microns. The second distance between the centres of the adjacent optical fibres in the set 110a and the set 110b is greater than the first distance i.e., the second pitch (D2) is greater than the first pitch (D1). The difference between the first and second distance is of the order of one to 100 percent of a diameter of an optical fibre of the plurality of optical fibres 112. With reference to FIG. 1D and FIG. 1E, it may be appreciated that in some aspects of the present disclosure where the pitches (D2) and (D1) differ by the defined values above, the groove portion (i.e., the at least one split-inducing region 150) may not be required. The greater pitch (D2) enables the at least one split inducing region 150.

FIG. 1G illustrates an isometric a sectional view of the unitary optical fibre ribbon 100. The single resin coat 130 of the unitary optical fibre ribbon 100 may have a top thickness 130tt and a bottom thickness 130tb. Specifically, the top thickness 130tt is of the single resin coat 130 disposed on the top surface 120t, and the bottom thickness 130tb is of the single resin coat 130 disposed on the bottom surface 120b. In some aspects of the present disclosure, the top thickness 130tt may be greater than the bottom thickness 130tb. In some other aspects of the present disclosure, the bottom thickness 130tb may be greater than the top thickness 130tt. Specifically, the top thickness 130tt may be different from the bottom thickness 130tb. In some aspects of the present disclosure, the top thickness 130tt may be in a range of 10 microns to 40 microns. In some other aspects of the present disclosure, the bottom thickness 130tb may be in a range 10 microns to 40 microns and greater than the top thickness 130tt. In some aspects of the present disclosure, the single resin coat 130 may have a plurality of layers. The plurality of layers comprises first layers 112ar and 112br and a second layer 110r. The first layers 112ar and 112br may be disposed on the first and second sets 110a and 110b of the plurality of optical fibres 112. Further, the second layer 110r may be disposed on the arranged plurality of sets 110 of the plurality of optical fibres 112 over the first layers 112ar and 112br. In some aspects of the present disclosure, the first layers 112ar and 112br may be partially cured before fully curing the rest of the plurality of layers to form the unitary optical fibre ribbon 100. The first layers 112ar and 112br portion may be cured to a first predetermined percentage value. The second layer 110r portion may be cured to a second predetermined percentage value. In some aspects of the present disclosure, the second predetermined percentage value may be greater than the first predetermined percentage value. In some aspects of the present disclosure, a difference between the second predetermined percentage value and the first predetermined percentage value may be in a range of 5 percent (%) to 30% in absolute terms. For example, when the second predetermined percentage value is in a range of 90% to 99%, the first predetermined percentage value may be in a range of 70% to 85%. The partial curing of the first layers 112ar and 112br may facilitate to avoid over-curing of the first layers 112ar and 112br during second curing step and it also promotes good adhesion to the second layer 110r of the single resin coat 130. In some aspects of the present disclosure, the first layers 112ar and 112br and the second layer 110r may have identical chemical composition. In some aspects of the present disclosure, the first layer 112ar and 112br and the second layer 110r may be Ultra-Violet curable resin composed of reactive mono and oligomers, photo initiator and additives such that the resin may have a density in a range of 0.99 grams per centimetre cubic (g/cm3) to 1.09 g/cm3 at 30 Degree Celsius (° C.) and viscosity in arrange of 300-600 millipascals (mPa) at 30° C.

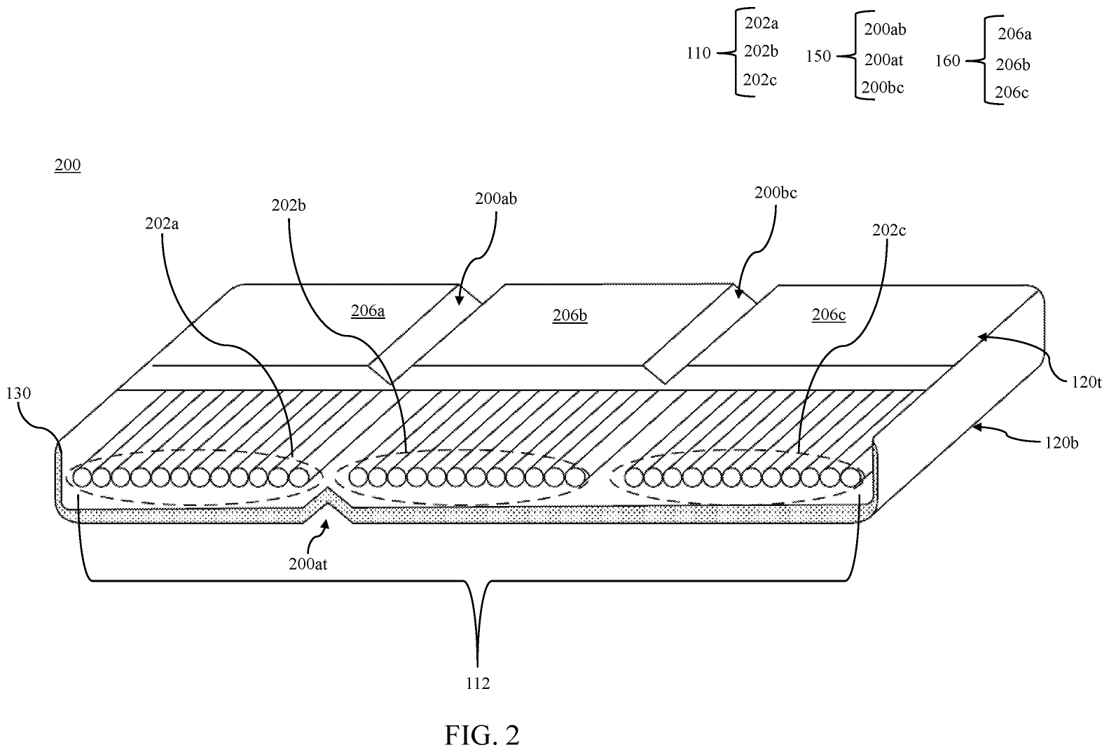

FIG. 2 illustrates a perspective sectional view of a unitary optical fibre ribbon 200. The unitary optical fibre ribbon 200 is substantially similar to the unitary optical fibre ribbon 100 of FIG. 1A with like elements referenced with like reference numerals. However, the unitary optical fibre ribbon 200 may have three sets in the plurality of sets 110 of the plurality of optical fibres 112. In other words, the plurality of sets 110 of the unitary optical fibre ribbon 200 may have three sets (i.e., a first set 202a, a second set 202b, and a third set 202c) of the plurality of optical fibres 112. As illustrated, the first set 202a may have 12 optical fibres, the second set 202b may have 12 optical fibres, and the third set 202c may have 12 optical fibres. Further, the unitary optical fibre ribbon 200 may have the at least one split-inducing region 150. Specifically, the at least one split-inducing region 150 may have three split inducing regions (i.e., a first split-inducing region 204ab, a second split-inducing region 204at, and a third split-inducing region 204bc). The first split-inducing region 204ab may be provided on the top surface 120t between the first and second sets 202a and 202b. Similarly, the third split-inducing region 204bc may be provided on the top surface 120t between the second and third sets 202b and 202c. However, the second split-inducing region 204at may be provided on the bottom surface 120b between the first set 202a and the second set 202b such that the first and second split-inducing region 204ab and 204at may be vertically aligned with one another. Specifically, the first and second split-inducing region 204ab and 204at may be positioned in a way such that the unitary optical fibre ribbon 200 is easily fractured along the first and second split-inducing region 204ab and 204at. As illustrated, the first split-inducing region 204ab and the third split-inducing region 204bc may define three the two or more flat regions 160. Specifically, the two or more flat regions 160 may have first through third flat regions 206a-206c such that the first through third flat regions 206a-206c are dimensionally similar to one another. As illustrated, the at least one split-inducing region 150 (i.e., the first through third split-inducing regions 204ab, 204at, and 204bc) may be a V-shaped groove that runs along a length of the unitary optical fibre ribbon 200. In some aspects of the present disclosure, the at least one split-inducing region 150 may be a U-shaped groove that runs along a length of the unitary optical fibre ribbon 200.

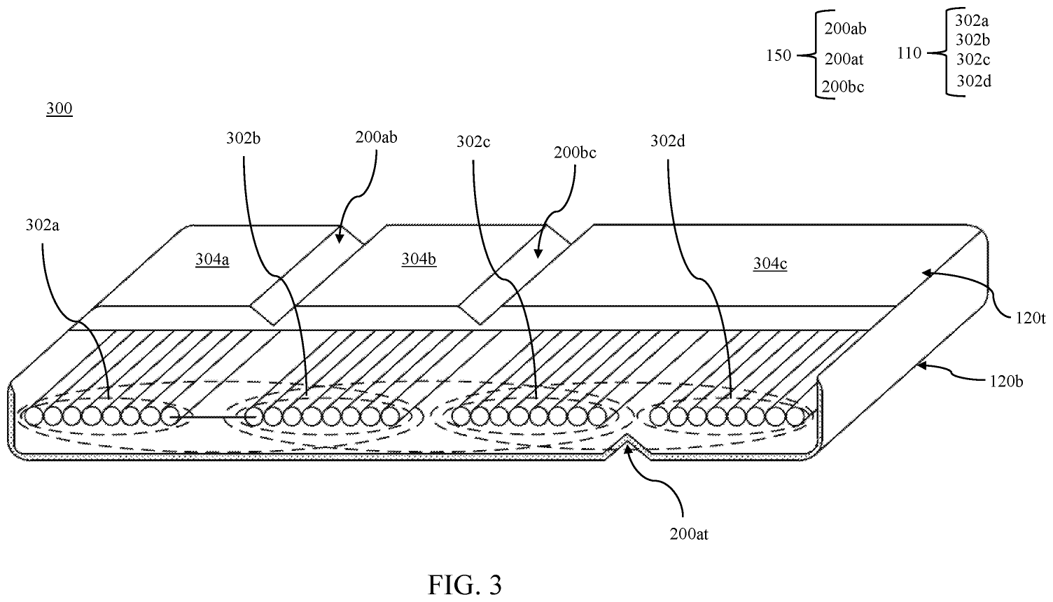

FIG. 3 illustrates a perspective view of a unitary optical fibre ribbon 300. The unitary optical fibre ribbon 300 is substantially similar to the unitary optical fibre ribbon 200 of FIG. 2 with like elements referenced with like reference numerals. However, a position of the at least one split-inducing region 150 (i.e., the first split-inducing region 204ab, the second split-inducing region 204at, and the third split-inducing region 204bc) may be different. Further, in the unitary optical fibre ribbon 300, the plurality of sets 110 of the plurality of optical fibres 112 may have four sets. In other words, the plurality of sets 110 of the unitary optical fibre ribbon 300 may have four sets (i.e., a first set 302a, a second set 302b, a third set 302c, and a fourth set 302d) of the plurality of optical fibres 112. Each set of the plurality of sets 150 of the plurality of optical fibres 112 of the unitary optical fibre ribbon 300 may have 8 optical fibres. Specifically, the first set 302a of the unitary optical fibre ribbon 300 has 8 optical fibres, the second set 302b of the unitary optical fibre ribbon 300 may have 8 optical fibres, the third set 302c of the unitary optical fibre ribbon 300 may have 8 optical fibres, and the fourth set 302d of the unitary optical fibre ribbon 300 may have 8 optical fibres.

Further, the unitary optical fibre ribbon 300 may have the at least one split-inducing region 150. Specifically, the at least one split-inducing region 150 may have three split inducing regions (i.e., the first split-inducing region 204ab, the second split-inducing region 204at, and the third split-inducing region 204bc). The first split-inducing region 204ab may be provided on the top surface 120t between the first and second sets 302a and 302b. Similarly, the third split-inducing region 204bc may be provided on the top surface 120t between the second and third sets 302b and 302c. However, the second split-inducing region 204at may be provided on the bottom surface 120b between the third set 302c and the fourth set 302d. Specifically, the first through third split-inducing region 204ab, 204at, 204bc may be positioned in a way such that the unitary optical fibre ribbon 300 is easily fractured at an interface of the first and second sets 302a and 302b, an interface of third and fourth sets 302c and 302d, and an interface of the second and third sets 302b and 302c, respectively. As illustrated, the at least one split-inducing region 150 (i.e., the first split-inducing region 204ab, the second split-inducing region 204at, and the third split-inducing region 204bc) may be a V-shaped groove that runs along a length of the unitary optical fibre ribbon 300. In some aspects of the present disclosure, the at least one split-inducing region 150 may be a U-shaped groove that runs along a length of the unitary optical fibre ribbon 300. Further, the first split-inducing region 204ab and the third split-inducing region 204bc may define the two or more flat regions 160. Specifically, the two or more flat regions 160 may have first through third flat regions 304a-304c such that the first and second flat regions 304a-304b are dimensionally similar to one another and the third flat regions 304c has a dimension greater than the first and second flat regions 304a-304b.

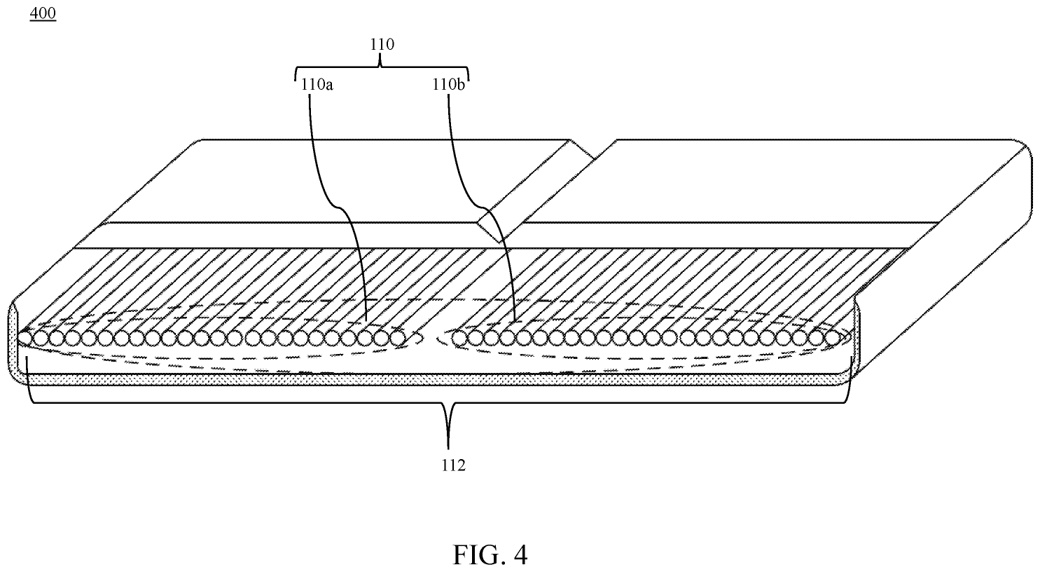

FIG. 4 illustrates a perspective view of a unitary optical fibre ribbon 400. The unitary optical fibre ribbon 400 is substantially similar to the unitary optical fibre ribbon 100 of FIG. 1A with like elements referenced with like reference numerals. However, in the unitary optical fibre ribbon 400, each set of the plurality of sets 110 of the optical fibres 112 has different number of optical fibres that that of the unitary optical fibre ribbon 100. Specifically, each of the first and second sets 110a and 110b may have 24 optical fibres.

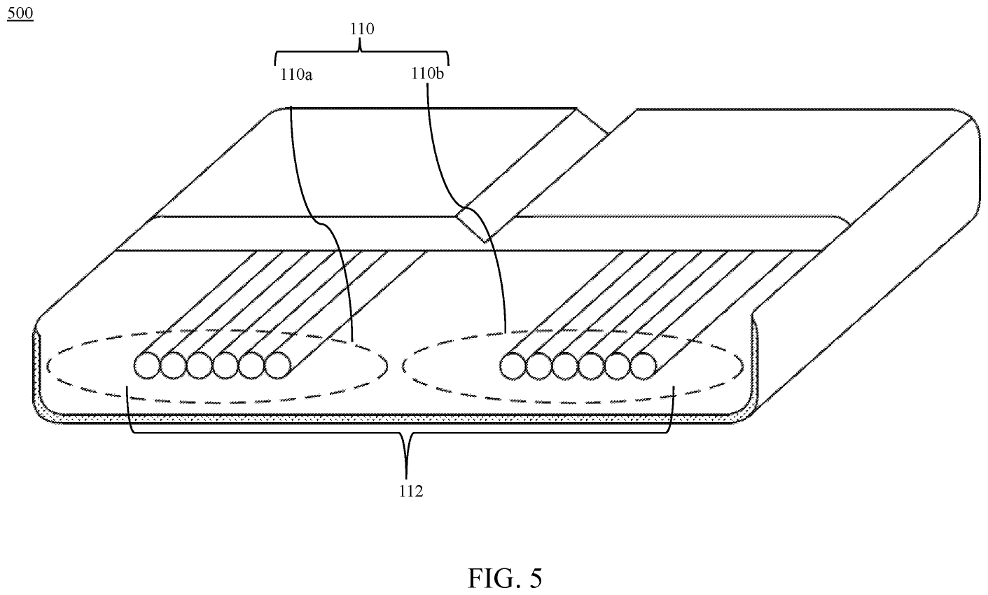

FIG. 5 illustrates a perspective view of a unitary optical fibre ribbon 500. The unitary optical fibre ribbon 500 is substantially similar to the unitary optical fibre ribbon 100 of FIG. 1A with like elements referenced with like reference numerals. However, in the unitary optical fibre ribbon 500, each set of the plurality of sets 110 of the optical fibres 112 has different number of optical fibres that that of the unitary optical fibre ribbon 100. Specifically, each of the first and second sets 110a and 110b may have 6 optical fibres.

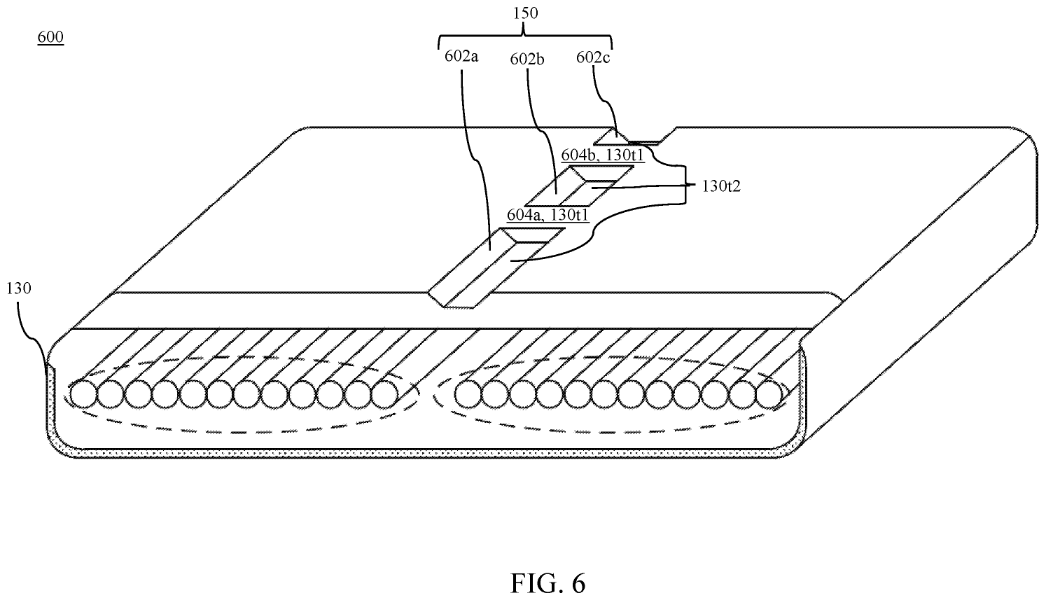

FIG. 6 illustrates an isometric sectional view of a unitary optical fibre ribbon 600. The unitary optical fibre ribbon 600 is substantially similar to the unitary optical fibre ribbon 100 of FIG. 1A with like elements referenced with like reference numerals. However, in the unitary optical fibre ribbon 600, the at least one split-inducing region 150 may be disposed along a length of the unitary optical fibre ribbon 600 in fragments. Specifically, the at least one split-inducing region 150 may be segregated along the length of the unitary optical fibre ribbon 600 to form a plurality of fragments 602a-602c such that the plurality of fragments 602a-602c are disposed at only some portions along the length of the unitary ribbon 600. As illustrated, due to the plurality of fragments 602a-602c of the at least one split-inducing region 150, the second coat thickness 130t2 of the single resin coat 130 that is less than the first coat thickness 130t1 is seen at only some portions along the length of the unitary ribbon 600 (i.e., at the plurality of fragments 602a-602c). Specifically, the plurality of fragments 602a-602c may be separated by a plurality of flat portions 604a-604b such that, at the plurality of flat portions 604a-604b, the single resin coat 130 has the first coat thickness 130t1.

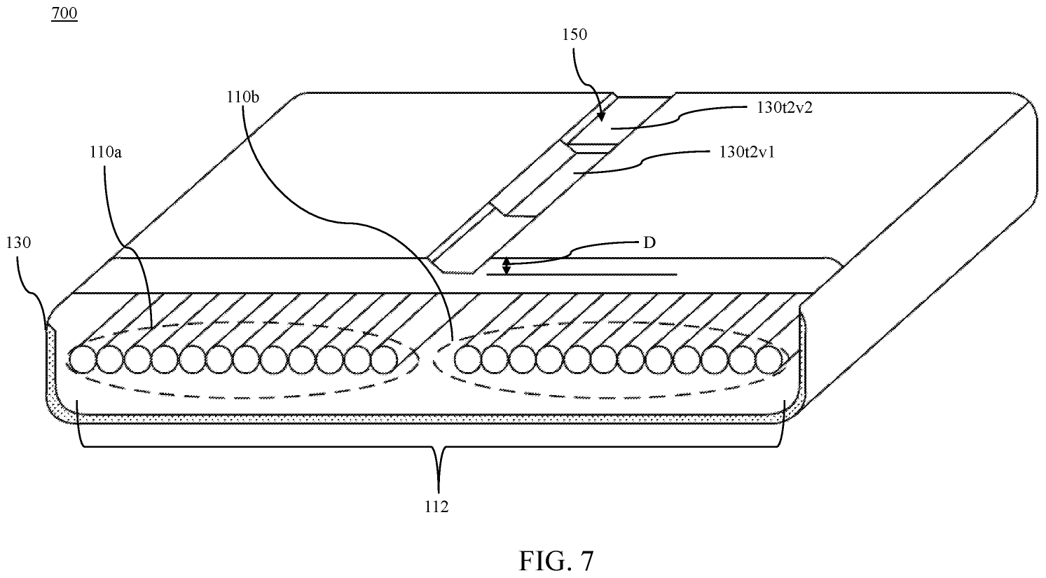

FIG. 7 illustrates an isometric sectional view of a unitary ribbon 700. The unitary optical fibre ribbon 700 is substantially similar to the unitary optical fibre ribbon 100 of FIG. 1A with like elements referenced with like reference numerals. However, in the unitary optical fibre ribbon 700, the single resin coat 130 may have a variable thickness along the length of at least one split inducing region 150. As illustrated, the second coat thickness 130t2 of the single resin coat 130 in the at least one split inducing region 150 varies between a thickness 130t2v1 and a thickness 130t2v2 along the length of the unitary optical fibre ribbon 700.

In some aspects of the present disclosure, the unitary optical fibre ribbon 700 may have one or more grooves (i.e., the split inducing region 150) between the at least one of pairs of adjacent sets 110a and 110b) of the plurality of optical fibres 112. The split inducing region 150, at least partially extend along length of unitary optical fibre ribbon 700. As illustrated, the split inducing region 150 at least partially extend along the length of the unitary optical fibre ribbon 700. The split inducing region 150 may have a penetration depth (D) in a range of 60 microns to 200 microns and a radius of curvature in a range of 0.01 millimetres (mm) to 0.04 mm. The unitary optical fibre ribbon 700 having the split inducing region 150 (i.e., a groove) with penetration depth of less than 60 microns will not be splitable by an external force in the range of 0.1 Newton to 0.5 Newton. The unitary optical fibre ribbon 700 having the split inducing region 150 (i.e., a groove) with penetration depth of more than 200 microns will not be sufficient mechanically robust to handle during manufacturing operations. The unitary optical fibre ribbon 700 having the split inducing region 150 (i.e., a groove) with radius of curvature of less than 0.01 mm is not feasible to manufacture without extreme precision tools. The unitary optical fibre ribbon 700 having the split inducing region 150 (i.e., a groove) with radius of curvature of more than 0.04 mm will not be splitable by an external force in the range of 0.1 Newton to 0.5 Newton.

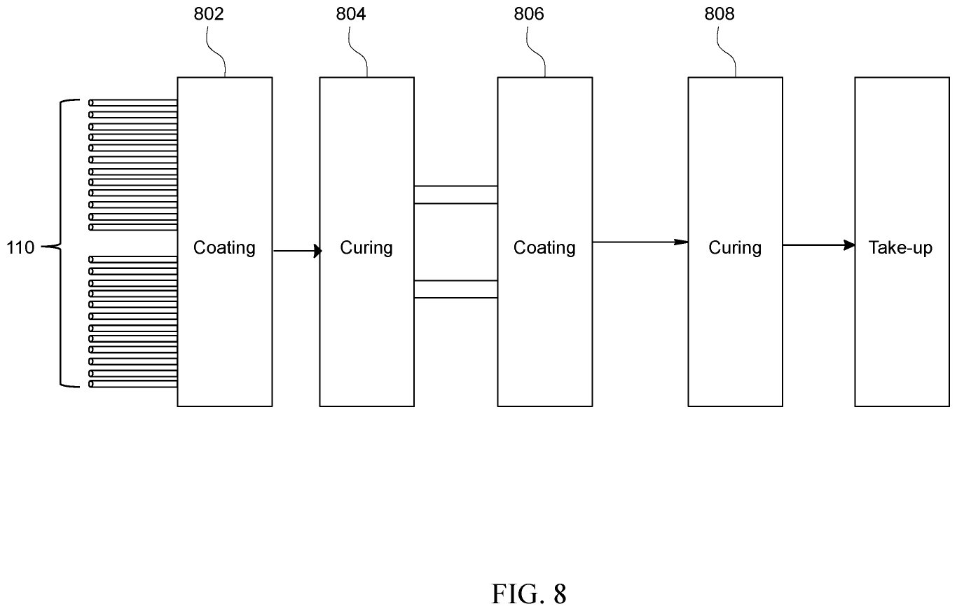

FIG. 8 illustrates a block diagram of a method 800 for manufacturing the unitary optical fibre ribbon 100, 170, 200, 300, 400, 500, 600, and 700.

At step 802, the first layers 112ar and 112br of the single resin coat 130 may be disposed on each set of the plurality of sets 110 of the plurality of optical fibres 112.

At step 804, the disposed first layers 112ar and 112br of the single resin coat 130 may be partially cured.

At step 806, the second layer 110r of the single resin coat 130 may be disposed on the arranged plurality of sets 110 of the optical fibres 112. In some aspects of the present disclosure, a predetermined resilience time gap may be ensured between the curing of the first layers 112ar and 112br and the rest of plurality of layers (i.e., the second layer 110r) of the single resin coat 130. In some aspects of the present disclosure, the predetermined resilience time gap may be ensured by maintaining a predetermined fixed distance between a first curing station (not shown) for curing the first layers 112ar and 112br and a second curing station (not shown) for curing the second layer 110r. In some aspects of the present disclosure, the predetermined resilience time gap may be in a range of 0.12 seconds to 1.2 seconds.

At step 808, the disposed single resin layer 130 may be fully cured on the arranged plurality of sets 110 of the optical fibres 112 to form the unitary optical fibre ribbon 100, 170, 200, 300, 400, 500, 600, and 700.

In some aspects of the present disclosure, the at least one split-inducing region 150 may be configured to break on application of at least a splitting force at edges of the unitary optical fibre ribbon 100, 170, 200, 300, 400, 500, 600, and 700. A user and/or an operator may apply at least the splitting force (threshold force) at the edges of the unitary optical fibre ribbon 100, 170, 200, 300, 400, 500, 600, and 700. The application of force may enable splitting of the unitary optical fibre ribbon 100, 170, 200, 300, 400, 500, 600, and 700 into one or more individual sets of the plurality of sets 110. Further, the individual sets of the plurality of sets 110 may remain intact as the split inducing region 150 will give-in on application of force by the user, being weaker than the rest of the fibre ribbon. A typical splitting force is substantially less than the force required to separate individual fibres of the plurality of optical fibres 112 from the plurality of sets 110. In some aspects of the present disclosure, the splitting force may be in the range of in the range of 0.1 Newton to 0.5 Newton. Every individual ribbon (i.e., a ribbon formed by each set of the plurality of sets 110) has an edge thickness that may be in a range of 1 micron to 20 microns. The edge thickness may be defined as the thickness of first layers 112ar and 112br at the edge of the plurality of optical fibres 112 of individual ribbon (i.e., a ribbon formed by each set of the plurality of sets 110) and an outer side surface of the individual ribbon (i.e., a ribbon formed by each set of the plurality of sets 110).

In some aspects of the present disclosure, a strength of the unitary optical fibre ribbon 100, 170, 200, 300, 400, 500, 600, and 700 at the at least one split-inducing region 150 may be at least 7% less than a strength of the unitary optical fibre ribbon 100, 170, 200, 300, 400, 500, 600, and 700 at the two or more flat regions 160. Specifically, the lower strength of the unitary optical fibre ribbon 100, 170, 200, 300, 400, 500, 600, and 700 at the at least one split-inducing region 150 may facilitate splitting of the unitary optical fibre ribbon 100, 200, 300, 400, 500, 600, and 700 with an external force in the range of 0.1 Newton to 0.5 Newton.

Advantageously, the unitary optical fibre ribbon 100, 170, 200, 300, 400, 500, 600, and 700 of the present disclosure achieves inline process for unitizing sets of optical fibres which are daughter ribbons using the single same resin/matrix material. Further, the disclosure provides a process of manufacturing a unitized ribbon by optimizing the chamber environment and curing levels to enable clean splitting of ribbon into desired number of sub-ribbons. The splitting force between the plurality of optical fibres 112 or the group of individual ribbons (i.e., ribbons formed by each set of the plurality of sets 110) may be controlled by the mechanical properties of the bonding matrix, the adhesive bonds between the joining material and each individual ribbons and the method of applying the load for the splitting. Moreover, the unitary optical fibre ribbon 100, 200, 300, 400, 500, 600, and 700 provides increased process efficiency, product outputs, and logistics, and also allows for improved individual ribbon breakout for mid-span access without specific technique or special tool requirements. The encapsulated ribbon of this invention, which is produced in the form of single Unitized ribbon module, has similar geometrical characteristics to the conventional method in discontinued manufacturing process, although, the aforementioned proposed solutions is given controlled breakout with advantage of easy strip into individual group of fibre or multiple groups of fibres from the unitized ribbon group for the mid-span access during the cable installation.

The foregoing descriptions of specific aspects of the present technology have been presented for the purpose of illustration and description. They are not intended to be exhaustive or to limit the present technology to the precise forms disclosed, and obviously many modifications and variations are possible in light of the above teaching. The aspects were chosen and described in order to best explain the principles of the present technology and its practical application, to thereby enable others skilled in the art to best utilize the present technology and various aspects with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible aspects of the invention have been described above and illustrated in some cases, it should be interpreted and understood as to have been presented only by way of illustration and example, but not by limitation. Thus, the breadth and scope of a preferred aspect should not be limited by any of the above-described exemplary aspects.

1. A unitary optical fibre ribbon comprising:
a plurality of optical fibres sandwiched between a plurality of layers of resin, where the plurality of layers of resin have two or more flat regions and at least one split-inducing region, where the at least one split-inducing region is positioned between one or more pairs of adjacent optical fibres, where the unitary optical fibre ribbon is fractured at the at least one split-inducing region by application of an external force in the range of 0.1 Newton to 0.5 Newton.

2. The unitary optical fibre ribbon of claim 1, where the at least one split-inducing region is defined by (i) a depth that is in a range of 60 micrometres (μm) to 200 μm, (ii) a radius of curvature in a range of 0.01 millimetres (mm) to 0.04 mm.

3. The unitary optical fibre ribbon of claim 1, where the plurality of optical fibres has a first pitch (D1) and a second pitch (D2) such that the first pitch (D1) is not equal to the second pitch (D2).

4. The unitary optical fibre ribbon of claim 3, where a ratio of the first pitch (D1) and the second pitch (D2) is less than 0.95.

5. The unitary optical fibre ribbon of claim 1, where the plurality of layers of resin is defined by (i) first layers of a first resin disposed over first and second sets, respectively, of the plurality of sets and (ii) a second layer of a second resin disposed on the arranged plurality of sets over the first layers, where the first resin and the second resin have identical composition.

6. The unitary optical fibre ribbon of claim 5, where the first layers have a first curing level and the second layer has a second curing level, where the second curing level is 5 to 30% more than the first curing level in absolute terms.

7. The unitary optical fibre ribbon of claim 5, where the first layers is partially cured and the second layer is fully cured.

8. The unitary optical fibre ribbon of claim 1, where the at least one split-inducing region has a coat thickness that varies along a length of the unitary optical fibre ribbon.

9. The unitary optical fibre ribbon of claim 1, where the plurality of layers of resin has a top thickness and a bottom thickness, wherein the top thickness is different from the bottom thickness.

10. The unitary optical fibre ribbon of claim 1, where a strength of the unitary optical fibre ribbon at the at least one split-inducing region is at least 7% less than a strength of the unitary optical fibre ribbon at two or more flat regions.
